(19) United States
(12) Patent Application Publication
(10) Pub. No.: US 2026/0193965 A1
(43) Pub. Date: Jul. 9, 2026

(54) Electrical Power Generation Using Reversible ESP Pump for Unconventional Wells

(71) Applicant: Baker Hughes Oilfield Operations LLC, Houston, TX (US)

(72) Inventors: Ricardo Hector Teves, Comodoro (AR); Charles Collins, Oklahoma City, OK (US)

(73) Assignee: Baker Hughes Oilfield Operations LLC, Houston, TX (US)

(21) Appl. No.: 19/129,294

(22) PCT Filed: Nov. 14, 2023
(86) PCT No.: PCT/US2023/037271

§ 371 Date: May 12, 2025

Related U.S. Application Data
(60) Provisional application No. 63/425,282, filed on Nov. 14, 2022.

(51) Int. Cl. E21B 41/00; E21B 43/12

(52) U.S. Cl. CPC E21B 41/0085; E21B 43/128

(57) ABSTRACT

A method for operating a pumping system includes placing the pumping system in a first mode of operation in which the passage of pressurized reservoir fluids through the pump induces a rotation in the pump that is transferred to a motor. The induced rotation in the motor generates electricity. The method includes the step of shifting the electric submersible pumping system Method of Operating ESP into a second mode of operation in which a drive current is applied to the motor to drive the pump to provide an artificial lift-based recovery of the reservoir fluids from the well. While the pumping system is operating in a generator mode, the pumping system can be configured to act as a choke to moderate the pressure Primary Recovery Under and flow of reservoir fluids under reservoir pressures.

### RELATED APPLICATIONS

This application claims the benefit of U.S. Provisional Patent Application Ser. No. 63/425,282 filed Nov. 14, 2022 and entitled, “Electrical Power Generation Using Reversible ESP Pump for Unconventional Wells,” the disclosure of which is here incorporated by reference.

### FIELD OF THE INVENTION

This invention relates generally to the field of pumping systems with electric motors, and more particularly, but not by way of limitation, to a system and method for generating electrical power using an electric submersible pumping system.

### BACKGROUND

In most oil and gas wells, the rate at which hydrocarbons are produced declines over time. Once the well has been drilled and completed using techniques like hydraulic fracturing, the well may experience a primary production or primary recovery stage in which the natural reservoir energy is sufficient to drive hydrocarbons to surface facilities through the well. If the natural reservoir pressure is sufficiently high, it may be necessary to install chokes on the surface or in the well to throttle the flow and pressure of the produced fluids.

When the natural reservoir energy declines, it may be necessary to deploy artificial lift systems to assist with the recovery of hydrocarbons from the well. Modern artificial lift systems include gas lift systems, rod pump systems and electric submersible pumping systems. As the natural reservoir pressure further declines, it may be useful to apply secondary recovery techniques such as water flooding to increase the production of fluids from the wellbore.

Artificial lift systems are often deployed after the natural reservoir pressure declines to an extent that limits the economic production of petroleum products from the well. This usually requires taking the well offline to permit the installation of the artificial lift systems. These installation efforts are expensive and time consuming, particularly if the production of hydrocarbons must be suspended during the installation project.

There is, therefore, a need for more cost-effective systems and methods for transitioning a well from natural production to artificial lift. It is to these and other deficiencies in the prior art that the present disclosure is directed.

### SUMMARY OF THE INVENTION

A method for operating an electric submersible pumping system includes placing the electric submersible pumping system in a first mode of operation in which the passage of pressurized reservoir fluids through the pump induces a rotation in the pump that is transferred to an electric motor. The induced rotation in the motor generates electricity, which is conducted to surface facilities through a power cable extending from a variable speed drive to the motor. The method includes the step of shifting the electric submersible pumping system into a second mode of operation in which a drive current is applied from the variable speed drive to the motor to drive the pump to provide an artificial lift-based recovery of the reservoir fluids from the well. While the electric submersible pumping system is operating in a generator mode, the electric submersible pumping system can be configured to act as a downhole choke to moderate the pressure and flow of reservoir fluids under reservoir pressures.

In other embodiments, the present disclosure is directed to a method for operating an electric submersible pumping system deployed in a well drilled for the production of reservoir fluids from a producing formation. The method begins with the step of producing reservoir fluids from the formation in a primary recovery phase under available and sufficient reservoir pressure. Next, the method includes the step of directing fluids from the formation through a pump within the electric submersible pumping system, whereby the movement of pressurized reservoir fluids through the pump forces the pump to rotate in a first direction. The method continues with the step of rotating the rotor of a motor within the electric submersible pumping system with the rotation of the pump in the first direction. Next, the method includes the steps of generating electricity in the motor through the rotation of the rotor within a stator, and conducting the generated electricity to surface facilities through a variable speed drive with a regeneration module. The generated electricity can be placed onto a power source connected to the variable speed drive.

The method continues by determining that reservoir pressure has declined to an extent that reservoir fluids can no longer be produced in an economic manner without intervention. Once this determination has been made, the method calls for switching the motor from a generator mode to a motor mode, and applying an electrical drive signal from the variable speed drive to the motor to energize the stator and force rotation of the rotor. The method concludes with the step of driving the pump with the motor to provide artificial lift to produce the reservoir fluids from the well.

In yet other embodiments, the present disclosure is directed at a method for operating a surface pump and a surface motor that are located on a surface and configured to cooperatively assist with the production of reservoir fluids from a well below the surface to the surface pump through production tubing. The method includes the step of producing the reservoir fluids from the well to the surface through the production tubing during a primary recovery phase in which the reservoir pressure is sufficient to force the reservoir fluids to the surface. The method also includes the steps of directing the reservoir fluids through the surface pump, whereby the movement of pressurized reservoir fluids through the surface pump forces impellers in the surface pump to rotate in a first direction, and rotating a rotor within the surface motor through the rotation of the impellers in the surface pump. The method continues with the step of generating electricity in the surface motor through the rotation of the rotor within a stationary stator of the surface motor.

### BRIEF DESCRIPTION OF THE DRAWINGS

FIG. 1 is a perspective view of a pumping system constructed in accordance with an exemplary embodiment during a power generation mode of operation.

FIG. 2 is a perspective view of a pumping system constructed in accordance with an exemplary embodiment during a pumping mode of operation.

FIG. 3 presents a process flow diagram for a method of transitioning a well from natural production to artificial lift based production.

FIG. 4 depicts an embodiment of the present invention in which the pumping system includes a surface pumping system.

### WRITTEN DESCRIPTION

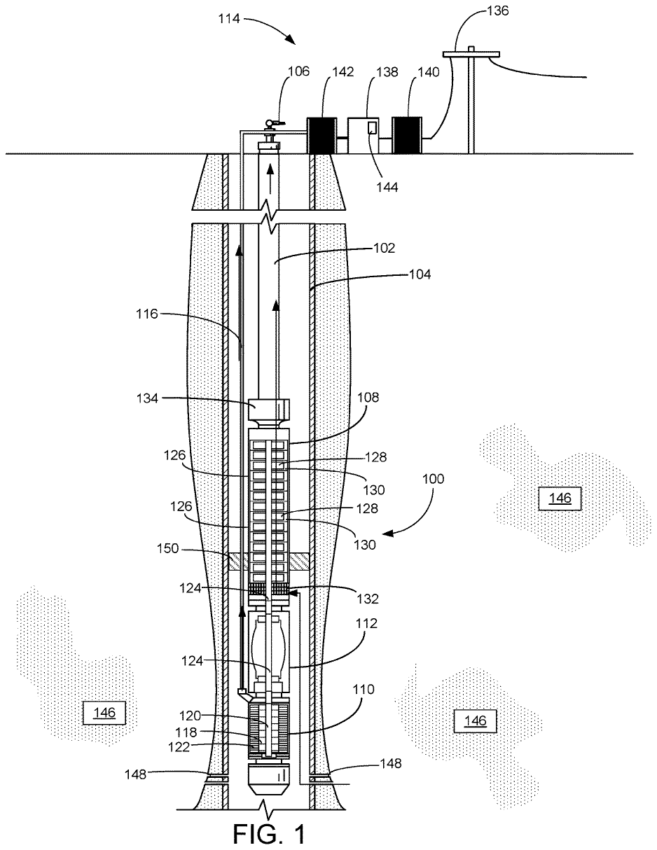

In accordance with exemplary embodiments of the present invention, FIG. 1 shows a perspective view of a pumping system 100 attached to production tubing 102. The pumping system 100 and production tubing 102 are disposed in a well 104, which is drilled for the production of a reservoir fluid such as water, brines or hydrocarbon fluids. The production tubing 102 connects the pumping system 100 to a wellhead 106 located on the surface. It will also be understood that, although the pumping system 100 of FIG. 1 is depicted in a conventional well 104, the pumping system 100 and methods disclosed herein will also find utility in horizontal or other non-vertical wells.

The pumping system 100 includes a pump 108, a motor 110 and a seal section 112. In exemplary embodiments, the motor 110 is a permanent magnet electric motor that receives power from surface facilities 114 through a power cable 116. The motor 110 includes a rotor 118 connected to a motor shaft 120, which together rotate inside a stator 122. In most embodiments, the rotor 118 includes a series of permanent magnets that are forced to rotate in response to electromagnetic fields generated by coils and windings extending through the stator 122. In other embodiments, the motor 110 is a three-phase induction motor in which rotating magnetic fields are established by the passage of current through windings in the stator 122 according to commutation phases. The induced magnetic fields cause the rotor 118 to rotate in accordance with well-known electromagnetic principles. Unless otherwise specified, as used herein the term “motor” refers to both permanent magnet and induction motors.

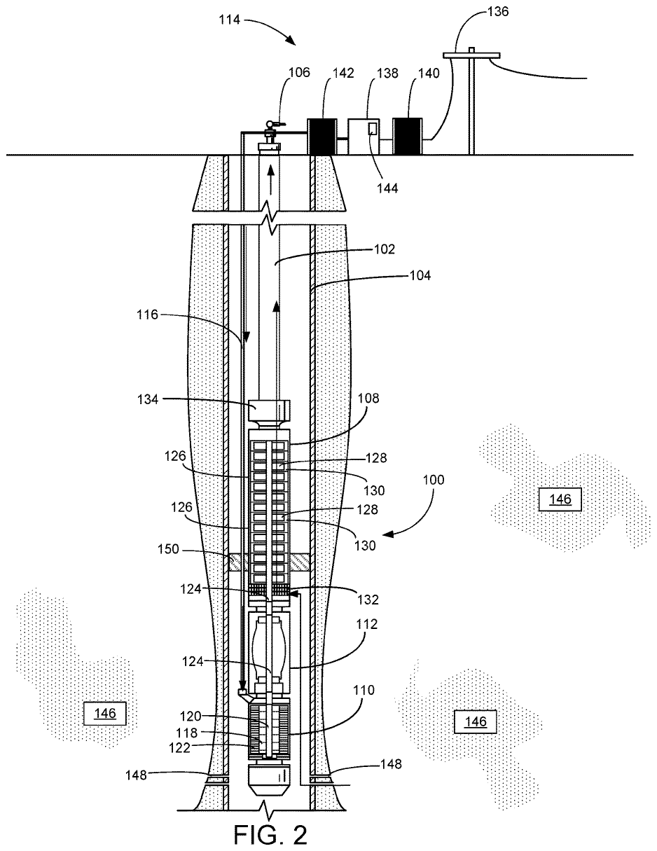

When the stator 122 is energized, the rotor 118 and motor shaft 120 drive the pump 108 through a drive shaft 124, which may include a series of interconnected shafts extending through the seal section 112 and pump 108. Although the exemplary embodiments are not so limited, the pump 108 depicted in FIGS. 1 and 2 is a turbomachine that includes a plurality of stages 126. Each stage 126 includes a rotary impeller 128 connected to the drive shaft 124 and a stationary diffuser 130. When driven, the impellers 128 rotate within the stationary diffusers 130. Each impeller 128 and diffuser 130 is generally configured to permit or encourage movement of fluids from a pump intake 132 to a pump discharge 134, which moves fluids from the pump 108 to the wellhead 106 through the production tubing 102.

The seal section 112 shields the motor 110 from mechanical thrust produced by the pump 108 and provides for the expansion of motor lubricants during operation. The seal section 112 also isolates the motor 110 from the wellbore fluids passing through the pump 108. As illustrated in FIGS. 1 and 2, the seal section 112 is generally positioned between the pump intake 132 and the motor 110.

The surface facilities 114 provide power and control to the motor 110. The surface facilities 114 include a power source 136, a variable speed drive (VSD) 138, an upstream transformer 140 and a downstream transformer 142. The power source 136 can be a public or private electrical grid (as shown), or a localized microgrid that is powered by a remote generator. The upstream and downstream transformers 140, 142 are configured to increase or decrease the voltage of electricity flowing to and from the variable speed drive 138.

During a normal pumping mode of operation, the variable speed drive 138 can be configured to produce a low voltage, pulse width modulated (PWM) current at a selected frequency. The waveform produced by the variable speed drive 138 can be adjusted manually or automatically to adjust the operating parameters of the pumping system 100. The output of the variable speed drive 138 is provided to the downstream transformer 142, where the voltage is modified to the design voltage range of the motor 110.

Unlike common variable speed drives that are designed only to control the excitation of the motor 110, the variable speed drive 138 also includes a regeneration module 144. The regeneration module 144 is configured to receive an electrical current from the motor 110 and output a corresponding electrical current to the upstream transformer 140 and power source 136. In this way, the variable speed drive 138 is configured as a “regenerative” drive that is capable of two fundamental modes of operation: a drive mode in which the variable speed drive 138 outputs a drive current to the motor 110; and a generator mode in which the motor 110 outputs a generated current to the variable speed drive 138, which can be loaded onto the power source 136. The regeneration module 144 can include an insulated-gate bipolar transistor (IGBT) bridge arrangement or other circuits commonly found in regenerative drive systems.

In FIG. 1, the well 104 has recently been completed and the natural reservoir pressure is forcing petroleum fluids from the producing formation 146 into the well 104 through perforations 148. A packer 150 or other zonal isolation device can optionally be used to force fluids produced from the formation 146 into the pump intake 132, where the pressurized fluids force the impellers 128 to rotate within the diffusers 130. The rotating impellers 128 turn the drive shaft 124 and motor shaft 120, which in turn cause the motor rotor 118 to rotate within the stator 122. The rotation of the rotor 118 within the stator 122 induces electric current within the stator 122, which is conducted from the motor 110 to the variable speed drive 138 through the power cable 116. The regeneration module 144 conditions the power so that it can be placed onto the power source 136, either directly or through the upstream transformer 140.

Thus, the power generated by the motor 110 in this generator mode of operation is caused by the movement of pressurized fluids through the pump 108. The power generated by the motor 110 in this mode of operation can be used to offset power requirements for other equipment or facilities in the field around the well 104, or it can be placed onto the power source 136 as a credit against other power costs. Although the regeneration function is effective at recovering energy from naturally pressurized fluids, the pump 108 is also well-suited for recovering energy imparted to the wellbore fluids by artificially-induced pressure systems, including hydraulic fracturing or injection systems.

Importantly, the pump 108 and motor 110 cooperate to function as a downhole choke, which moderates the movement and pressure of fluid discharged from the well 104. In prior art systems, chokes in the wellhead 106 are used to throttle the production of hydrocarbons from the well 104 to prevent damage to the well 104 and surface facilities, while optimizing the production of the hydrocarbons. Rather than relying primarily on chokes on the wellhead 106, the regenerative braking force applied by the motor 110 in opposition to the induced rotation of the impellers 128 within the pump 108 slows the movement of fluid through the pump 108 and production tubing 102. This presents an economically attractive alternative to the use of standard surface-based chokes in which the energy present in the pressurized fluids is discarded without serving a power generation function.

In exemplary embodiments, the variable speed drive 138 can adjust the braking force applied by the windings in the stator 122 to adjust the extent to which the pump 108 reduces the pressure and flow of fluids passing through the pump 108 to the surface facilities 114. In this way, the generator function of the pumping system 100 can be operated according to a control scheme to optimize power generation, or to optimize the production hydrocarbons from the well 104, or to balance the generation of power and the production of hydrocarbons. In some embodiments, the generator function of the pumping system 100 is adjusted in response to changing power requirements for other equipment in the same field as the well 104. In other embodiments, the braking force applied to the impellers 128 of the pump 108 by the motor 110 can be adjusted by sending a controlled braking signal from the variable speed drive 138 to the motor 110 to change the rotational speed of the motor 110 and pump 108. In some embodiments, the variable speed drive 138 can rapidly adjust the motor 110 operation by alternating the controlled braking signal with the receipt of power generated by the motor 110.

When the reservoir pressure in the formation 146 declines to an extent that is insufficient to economically generate power while recovering hydrocarbons from the well 104, the regeneration module 144 can reduce the braking force applied by the stator 122 to the rotor 118 within the motor 110. Eventually, the reservoir pressure can decline to an extent that the produced hydrocarbons cannot be pushed to the surface facilities 114 without assistance from an artificial lift system. At that time, the pumping system 100 can be placed into the second mode of operation in which the variable speed drive 138 applies an electrical drive current to the motor 110 through the power cable 116. When the stator 122 is energized, the rotor 118 spins the motor shaft 120, drive shaft 124 and impellers 128 to force the hydrocarbons to the surface through the production tubing 102. Depending on conditions in the formation 146 and well 104, the pumping system 100 can be switched back and forth between the generator and motor modes of operation.

In some embodiments, the motor 110 and pump 108 can be configured for deployment and removal through a wireline or coiled tubing system, such as the TransCoil rigless-deployed coiled tubing ESP system offered by Baker Hughes. Deploying the pumping system 100 as a more easily retrievable system allows the operator to more cost-effectively resize the pumping system 100 to match changing conditions in the well 104, without sacrificing the benefits available through the power generation.

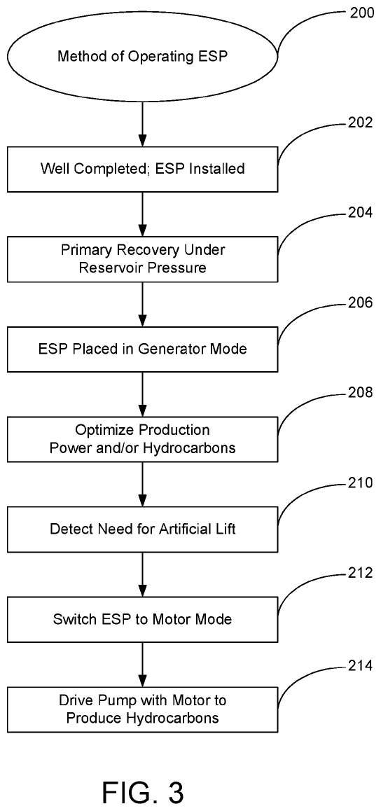

Turning to FIG. 3, shown therein is a process flow diagram illustrating a method 200 for operating the pumping system 100 within the well 104. In a first step 202, the well 104 is completed and the pumping system 100 is installed in the well 104. At step 204, hydrocarbons under natural pressure from the formation 146 are directed to the wellhead 106 and downstream storage or processing facilities. At step 206, the pumping system 100 is placed into a generator mode of operation. At step 208, the braking force applied by the motor 110 is adjusted according to a control scheme to optimize the production of electricity, the production of hydrocarbons, or to balance the production of hydrocarbons and electricity.

At step 210, a condition is detected that justifies discontinuing the production of power with the motor 110. This condition could be a determination that the artificial lift system is required to economically recover hydrocarbons from the well 104. At step 212, the motor 110 is switched from a generator mode of operation to the motor mode of operation in which a drive current is applied by the variable speed drive 138 to the motor 110. At step 214, the pump 108 is driven by the motor 110 to push the hydrocarbons from the formation 146 to the wellhead 106.

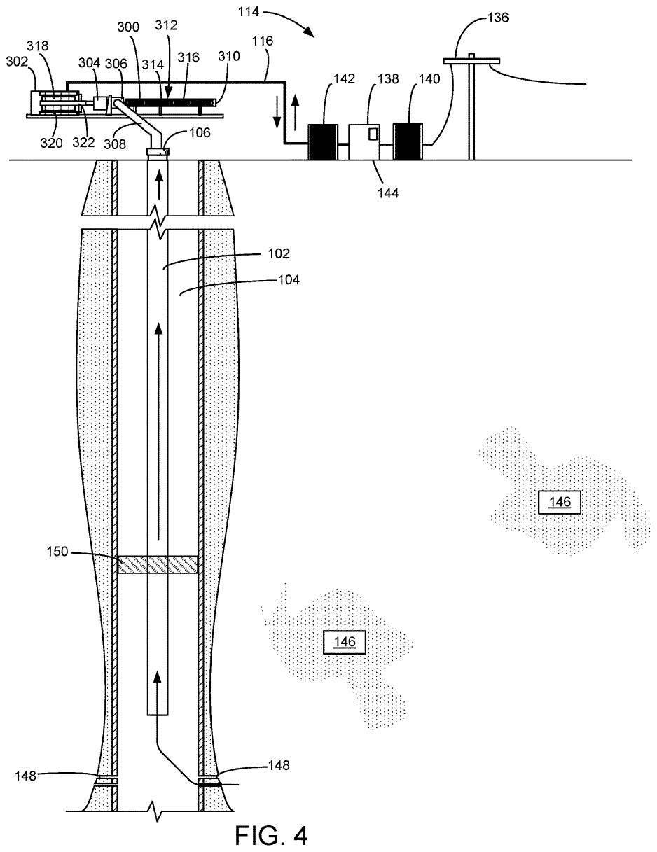

Turning to FIG. 4, shown therein is an embodiment in which the pumping system 100 includes a surface pump 300 driven by a surface motor 302. The surface pump 300 includes a suction chamber 304 and a thrust bearing assembly 306 between the surface pump 300 and the surface motor 302. The suction chamber 304 is connected to the wellhead 106 through an inlet line 308. The surface pump 300 includes a discharge 310 on the opposite side of the surface pump 300 from suction chamber 304. As explained above with reference to the downhole pump 108, the surface pump 300 also includes one or more pump stages 312 that each include an impeller 314 configured for rotation within a corresponding diffuser 316. In exemplary embodiments, the surface pump 300 includes a plurality of stages 312.

The surface motor 302 includes a rotor 318, a stator 320 and a motor shaft 322. The impellers 314 are coupled directly or indirectly to the motor shaft 322. The surface motor 302 can be an induction motor or a permanent magnet motor, as described above with reference to the downhole motor 110. The surface motor 302 is connected to the variable speed drive 138 and regeneration module 144 through the power cable 116.

The surface pump 300 and surface motor 302 can be operated in accordance with the method 200 disclosed in FIG. 3. During a generator mode of operation (as depicted in FIG. 4), pressurized reservoir fluids from the formation 146 pass through the production tubing 102 and wellhead 106 to the suction chamber 304 through the inlet line 308. As the pressurized reservoir fluids move through the pump 300 from the suction chamber 304 to the discharge 310, the pressurized fluids force the impellers 314 within the surface pump 300 to rotate, thereby causing the rotor 318 in the surface motor 302 to rotate. The rotation of the rotor 318 within the stator 320 produces an electric current that is passed to the regeneration module 144 of the variable speed drive 138. The power generated by the surface motor 302 during the regeneration mode of operation can be placed onto the grid or other power source 136.

Importantly, forcing pressurized wellbore fluids through the surface pump 300 also provides a choke function to reduce or throttle the pressure and flow of the pressurized fluids. The regeneration module 144 and variable speed drive 138 can adjust the power generating function of the surface motor 302 to increase or decrease the resistance applied by the surface pump 300 to increase or decrease the choke effect applied by the surface pump 300. Like the embodiment disclosed in FIGS. 1-2, this presents an economically attractive alternative to the use of standard surface-based chokes in which the energy present in the pressurized fluids is discarded without serving a power generation function. Although the regeneration function is effective at recovering energy from naturally pressurized fluids, the surface pump 300 is also well-suited for recovering energy imparted to the wellbore fluids by artificially-induced pressure systems, including hydraulic fracturing or injection systems.

When the pressure of the fluids in the reservoir drops to an extent at which artificial lift becomes desirable to recover the fluids from the well 104, the surface motor 302 can be placed into a motor mode of operation in which a drive current is applied to the surface motor 302 by the variable speed drive 138. When energized, the surface motor 302 drives the impellers 314 in the surface pump 300 to move fluids from the suction chamber 304 to downstream facilities through the discharge 310.

It is to be understood that even though numerous characteristics and advantages of various embodiments of the present invention have been set forth in the foregoing description, together with details of the structure and functions of various embodiments of the invention, this disclosure is illustrative only, and changes may be made in detail, especially in matters of structure and arrangement of parts and steps within the principles of the present invention to the full extent indicated by the broad general meaning of the terms in which the appended claims are expressed. It will be appreciated by those skilled in the art that the teachings of the present invention can be applied to other systems without departing from the scope and spirit of the present invention.

What is claimed is:

1. A method for operating an electric submersible pumping system deployed in a well drilled for the production of reservoir fluids from a producing formation, the method comprising the steps of:
producing reservoir fluids from the formation in a primary recovery phase under available and sufficient reservoir pressure;
directing the pressurized reservoir fluids from the formation through a pump within the electric submersible pumping system, whereby the movement of pressurized reservoir fluids through the pump forces impellers in the pump to rotate in a first direction;
rotating the rotor of a motor within the electric submersible pumping system with the rotation of the impellers in the pump; and
generating electricity in the motor through the rotation of the rotor within a stationary stator.

2. The method of claim 1, further comprising the step of conducting the electricity generated by the motor through a power cable to a variable speed drive in surface facilities with a regeneration module.

3. The method of claim 2, further comprising the step of placing the generated electricity onto a power source connected to the variable speed drive.

4. The method of claim 3, wherein following the generating step the method further comprises the step of adjusting the operation of the motor with the variable speed drive in accordance with a choke function to optimize the production of reservoir fluids from the well.

5. The method of claim 4, wherein the step of adjusting the operation of the motor with the variable speed drive in accordance with the choke function further comprises resisting the rotation of the impellers by applying a control signal to the motor from the variable speed drive to adjust the rotation of the rotor within the stator of the motor.

6. The method of claim 1, further comprising the steps of:
determining that reservoir pressure has declined to an extent that reservoir fluids can no longer be produced in an economic manner without intervention;
switching the motor from a generator mode to a motor mode;
applying a drive voltage from the variable speed drive to the motor through the power cable to energize the stator and force rotation of the rotor; and
driving the impellers in the pump with the motor to provide artificial lift to produce the reservoir fluids from the well.

7. The method of claim 6, wherein the step of driving the pump with the motor comprises driving the pump in the first direction to produce the reservoir fluids from the well.

8. The method of claim 6, further comprising the steps of:
determining that conditions in the well have changed and intervention is no longer required to economically produce the reservoir fluids; and
placing the motor back to the generator mode from the motor mode.

9. A method for controlling a pumping system to provide a choke function to pressurized fluids produced from a well, the method comprising the steps of:
producing the pressurized fluids from a formation under available and sufficient reservoir pressure;
directing the pressurized fluids from the formation through a pump, whereby the movement of pressurized fluids through the pump forces impellers in the pump to rotate in a first direction;
rotating the rotor of an electric motor within the pumping system through the rotation of the pump impellers in the first direction; and
generating electricity in the motor through the rotation of the rotor within a stationary stator in the motor.

10. The method of claim 9, further comprising the step of transferring the generated electricity to a power source through a variable speed drive.

11. The method of claim 10, further comprising the step of adjusting the operation of the motor with the variable speed drive to resist the rotation of the rotor to control the pressure and flow of the pressurized fluids through the pump while generating electricity.

12. The method of claim 9, wherein the pump is a submersible pump that is connected to a motor within a submersible pumping system.

13. The method of claim 9, wherein the pump is a surface pump that is connected to a surface motor.

14. The method of claim 9, further comprising the steps of:
switching the motor from a generator mode to a motor mode;
applying a drive voltage from the variable speed drive to the motor to energize the stator and force rotation of the rotor; and
driving the pump with the motor to provide artificial lift to produce the fluids from the well.

15. A method for operating a surface pump and a surface motor that are located on a surface and configured to cooperatively assist with the production of reservoir fluids from a well below the surface to the surface pump through production tubing, the method comprising the steps of:
producing the reservoir fluids from the well to the surface through the production tubing during a primary recovery phase in which the reservoir pressure is sufficient to force the reservoir fluids to the surface;
directing the reservoir fluids through the surface pump, whereby the movement of pressurized reservoir fluids through the surface pump forces impellers in the surface pump to rotate in a first direction;
rotating a rotor within the surface motor through the rotation of the impellers in the surface pump; and
generating electricity in the surface motor through the rotation of the rotor within a stationary stator of the surface motor.

16. The method of claim 15, further comprising the step of conducting the electricity generated by the surface motor to a variable speed drive with a regeneration module.

17. The method of claim 16, further comprising the step of placing the generated electricity onto a power source connected to the variable speed drive.

18. The method of claim 17, wherein following the generating step the method further comprises the step of adjusting the operation of the surface motor with the variable speed drive in accordance with a choke function to optimize the production of reservoir fluids from the well.

19. The method of claim 17, wherein the step of adjusting the operation of the surface motor with the variable speed drive in accordance with the choke function further comprises resisting the rotation of the impellers by applying a controlled braking signal to the surface motor from the variable speed drive to change the rotational speed of the surface motor to alter an active braking force to resist the rotation of the rotor within the stator of the surface motor.

20. The method of claim 15, further comprising the steps of:
determining that reservoir pressure has declined to an extent that reservoir fluids can no longer be produced in an economic manner without intervention;
switching the surface motor from a generator mode to a motor mode;
applying a drive current from the variable speed drive to the surface motor to energize the stator and force rotation of the rotor; and
driving the impellers in the surface pump with the surface motor to assist with the production of reservoir fluids from the well.
